(19) United States
(12) Patent Application Publication
(10) Pub. No.: US 2005/0142515 A1
(43) Pub. Date: Jun. 30, 2005

(54) Dental tool having a hand grip

(76) Inventors: Hiam Levy, Hod Hasharon (IL); Benjamin Atkin, Miami, FL (US); Kenneth Rosenblood, Los Angeles, CA (US); Robert Hayman, Pacific Pallsades, CA (US)

Correspondence Address: BERGMAN KUTA LLP, P. O. BOX 400167, CAMBRIDGE, MA, 02140, US

(21) Appl. No.: 10/998,259

(22) Filed: Nov. 26, 2004

Related U.S. Application Data
(63) Continuation-in-part of application No. 10/879,554, filed on Jun. 28, 2004.
(63) Continuation-in-part of application No. 10/735,147, filed on Dec. 12, 2003.
(63) Continuation-in-part of application No. 10/735,050, filed on Dec. 12, 2003.
(63) Continuation-in-part of application No. 10/734,517, filed on Dec. 12, 2003.
(60) Provisional application No. 60/524,904, filed on Nov. 26, 2003.
(60) Provisional application No. 60/524,903, filed on Nov. 26, 2003.
(60) Provisional application No. 60/624,840, filed on Nov. 3, 2004.
(60) Provisional application No. 60/624,883, filed on Nov. 4, 2004.
(60) Provisional application No. 60/482,717, filed on Jun. 27, 2003.
(60) Provisional application No. 60/432,652, filed on Dec. 12, 2002.
(60) Provisional application No. 60/432,654, filed on Dec. 12, 2002.
(60) Provisional application No. 60/524,903, filed on Nov. 26, 2003.
(60) Provisional application No. 60/432,653, filed on Dec. 12, 2002.
(60) Provisional application No. 60/524,904, filed on Nov. 26, 2003.

(51) Int. Cl. A61C 3/00

(52) U.S. Cl. 433/114

(57) ABSTRACT

The present invention relates to a hand grip for dental instruments that provides a dental professional with a more secure and comfortable means of grasping a dental hygiene tool. In one embodiment, the instrument has an elongated dental handpiece having an interior that is solid, hollow or partially solid. The elongated handpiece has a distal end and a proximal end and a longitudinal portion in between. A grip portion is attached to the body of the handpiece anywhere between the distal end and the proximal end, comprising a grip stop against which the operator's hand rests while gripping the handpiece and using the tool. At least one insert is present on the handpiece at an end. A locking mechanism for locking the position of the grip anywhere along the handpiece is also disclosed. The handgrip can be fitted to any handpiece or a set of handpieces having varying diameters, some of which can also include a vibrator.

### CROSS-REFERENCE TO RELATED APPLICATIONS

The present invention claims the benefit of U.S. Provisional Patent Application No. 60/524,904 filed Nov. 26, 2003 and titled “Ultrasonic Insert for Dental Hygiene Tools”; U.S. Provisional Patent Application No. 60/524,903 filed Nov. 26, 2003 and titled “Hand Grip for Dental Hygiene Tools”; U.S. Provisional Patent Application No. 60/624,883 filed Nov. 3, 2004 and titled “Dental Instrument” with Attorney Docket No. D2000-0005-P001; and U.S. Provisional Patent Application No. 60/624,840 filed Nov. 3, 2004 and titled “Dental Instruments with Stress Relief” with Attorney-Docket No. D2000-0006-P001, the disclosure of each of the foregoing being herewith incorporated by reference in its entirety.

The present invention is a continuation-in-part of U.S. Nonprovisional patent application Ser. No. 10/879,554 filed Jun. 28, 2004 and titled “Ultrasonic Dental Tool Having a Light Source” with Attorney Docket No. D359 51293 which claims the benefit of U.S. Provisional Patent Application No. 60/482,717 filed Jun. 27, 2003 and titled “Ultrasonic Dental Tool Insert with Disposable Lighted Tip”; a continuation-in-part of U.S. Nonprovisional patent application Ser. No. 10/735,147 filed Dec. 12, 2003 and titled “Ultrasonic Dental Insert Having Interchangeable Plastic and Metal Tips” which claims the benefit of U.S. Provisional Patent Application No. 60/432,652 filed Dec. 12, 2002; a continuation-in-part of U.S. Nonprovisional patent application Ser. No. 10/735,050 filed Dec. 12, 2003 and titled “Ultrasonic Dental Handpiece Having a Rotatable Head” which claims the benefit of U.S. Provisional Patent Application No. 60/432,654 filed Dec. 12, 2002 and U.S. Provisional Patent Application No. 60/524,903 filed Nov. 26, 2003; and a continuation-in-part of U.S. Nonprovisional patent application Ser. No. 10/734,517 filed Dec. 12, 2003 and titled “Ultrasonic Dental Insert Having a Hand Grip Fitted to a Retaining Ring” which claims the benefit of U.S. Provisional Patent Application No. 60/432,653 filed Dec. 12, 2002 and U.S. Provisional Patent Application No. 60/524,904 filed Nov. 26, 2003, the disclosure of each of the foregoing being herewith incorporated by reference in its entirety.

### FIELD OF THE INVENTION

The present invention relates to dental a instrument having a hand grip for grasping by a dental professional. In particular, the present invention relates to a handheld dental instrument having a hand grip for grasping by a dental professional.

### BACKGROUND

The dental instruments used today all have handles or grasping portions in one form or another. Repetitive use of the instruments during the day causes repetitive stress to the hands, wrists, and elbows. This can lead to carpal tunnel syndrome (CTS) and cumulative trauma disorder (CTD) among dental hygienists, dentists and other dental professionals.

Even with ergonomically designed handles, the hand can get tired or sweaty and an insecure grip can slip and cause unwanted actions by the dentist.

### SUMMARY OF THE INVENTION

Therefore, it is desirable to provide a secure hand grip for dental instruments, including ultrasonic dental tools; rotary instruments including endodontic files, abrasive burs, drills, abrasive disc; and prophy angles.

The present invention comprises a hand grip for dental instruments that provides a dental professional with a more secure and comfortable means of grasping a dental hygiene tool.

In one embodiment, the instrument comprises an elongated dental handpiece having an interior that is solid, hollow or partially solid. The elongated handpiece has a distal end and a proximal end and a longitudinal portion in between. A grip portion is attached to the body of the handpiece anywhere between the distal end and the proximal end, comprising a grip stop against which the operator's hand rests while gripping the handpiece and using the tool. At least one insert is present on the handpiece at an end.

In another embodiment, the hand grip is in the form of a pistol grip.

The hand grip portion slides onto the handpiece and can be stopped and locked into place at various points on the handpiece, to fit the hand size of different users. The locking mechanism can be adjusted by rotating the trigger on the grip and then sliding the grip forward or back on the handpiece. The grip functions as a contra balance and lever to the handpiece thus greatly reducing the pressure on the operator's fingers and wrist.

At least one end of the instrument has a dental tip extending therefrom, and removably connected to the end of the housing. At least one vibrator module is positioned and resiliently supported inside the housing towards one end of the body. The module has at least one small motor for rotating at least one eccentric weight to cause a vibration in the instrument. A battery is positioned inside the housing to power the vibrator module to excite the vibratory element. The battery can be disposable or rechargeable.

The present invention comprises sets of identical instruments, having handles made with varying diameters for grasping, designed to be used interchangeably throughout the day, thus cutting down on the repetitive grasping action through the change of grasp. Therefore, even if a dental professional uses the same type of instrument throughout the day, the hands, wrists and elbows can experience varying rather than repetitive action because the positioning of the hands, wrists and elbows are changing throughout the day. The dental instrument comprises an elongated housing having an interior that is solid, hollow or partially solid. The elongated body has a distal end and a proximal end. A portion of the housing serves as a handle for grasping by the dental professional. At least one dental tip extending therefrom, and removably connected to one end of the housing.

The present invention further relates to sets of identical instruments comprising handles with varying diameters for grasping, said handles having distal ends and proximal ends, the distal ends having at least a cone-shaped portion permanently attached or removably attached to the distal ends with its wider end, and dental tips extending from the narrower ends. The dental tips can be permanently attached or removably attached to the narrower ends of cone-shape portions. The cone-shape portions have hollow bodies. A vibrator module is positioned and supported inside the hollow body of each of the cone-shape portions. The vibrator module has a small motor for rotating an eccentric weight to cause a vibration in the tip and/or along the handle. A battery is positioned inside the hollow handle to power the vibrator module to excite the vibratory element. The battery can be disposable or rechargeable.

In addition, each of the instruments described above can also be made with an anti-rotation means for preventing said vibrator module from rotating relative to said housing when said vibratory tool is in use.

### BRIEF DESCRIPTION OF THE DRAWINGS

These and other aspects of the invention may be understood by reference to the following detailed description, taken in conjunction with the accompanying drawings, wherein:

FIG. 1 shows a side view of a handpiece fitted with a hand grip of the present invention;

FIG. 2 is a bottom view of a handpiece fitted with a hand grip of the present invention;

FIG. 3 shows an end view of a handpiece according to one embodiment of the invention

FIG. 4 shows an exploded view of a hand grip according to one embodiment of the invention;

FIG. 5 shows a top view of a handpiece according to one embodiment of the invention; and

FIG. 6 illustrates a cross-sectional view of the handpiece having of FIG. 5.

FIG. 7 shows a conventional passive dental instrument;

FIG. 8 shows an active dental instrument according to one embodiment of the invention.

FIG. 9 shows a block diagram illustrating various functional components of a dental instrument according to one embodiment of the invention.

FIG. 10a-d show a perspective view of a set of dental instruments with varying handle diameters.

FIG. 11 shows a cutaway view of an active dental instrument according to one embodiment of the invention.

FIG. 12 shows a perspective of another ergonomically designed dental instrument of the present invention including a rotatable tip.

### DETAILED DESCRIPTION

A dental drill comprises a drill bit insert; a rotary tool comprises an insert, such as a multi-use diamond dental bur, a dental carbide bur, a dental sintered diamond bur, a dental diamond disc, a dental laboratory tungsten carbide cutter, or dental steel bur; an endodontic instrument comprises an endodontic file or reamer; and a prophy angle comprises a longitudinal body and a prophy cup. The insert comprises a shank or attachment adapted to be fitted into a handpiece. The handpiece can be the same or different for the various instruments, but the hand grip can comprise the same type and mechanism, as described in more detail below.

In one exemplary embodiment of the invention, the instrument comprises an elongated dental handpiece 1 having an interior that is solid, hollow or partially solid. The elongated handpiece 10 has a distal end and a proximal end and a longitudinal portion in between. A grip portion 10 is attached to the body of the handpiece anywhere between the distal end and the proximal end that is comfortable for the operator to hold. The grip portion comprises a grip stop 11 against which the operator's hand rests while gripping the handpiece and using the tool. At least one insert is present on the handpiece at an end (not shown).

The grip 10 as shown in the Figures are fitted such that it can slide onto the handpiece and can be stopped and locked into place at various points on the handpiece, to fit the hand size of different users. In one embodiment, the hand grip is in the shape of a pistol grip with a locking mechanism that can be adjusted by rotating the trigger on the grip and then sliding the grip forward or backward on the handpiece. The grip functions as a contra balance and lever to the handpiece thus greatly reducing the pressure on the operator's fingers and wrists.

In one embodiment, the locking mechanism that can be incorporated into the grip is a lever connected to a cam surface that engages the outer surface of the handpiece as the lever is pressed. The positive pressure developed by the cam surface secures the grip to the handpiece in one of several available positions depending on the preference of the user.

In other embodiments, other locking mechanisms that secure the grip in place either by positive pressure on the external surface of the handpiece or by interlocking with an element of the handpiece can be used. Positioning the grip will normally be a function of comfort and ease of maneuvering the tool for the user.

The grip can be fitted onto a rotating ultrasonic handpiece, as described in U.S. patent application Ser. No. 10/735,050 entitled “Ultrasonic Dental Handpiece Having a Rotatable Head” and U.S. patent application Ser. No. 10/734,517 entitled “Ultrasonic Dental Insert Having a Hand Grip Fitted to a Retaining Ring,” all filed Dec. 12, 2003, the entire contents of all three of which are incorporated by reference herein, or a standard ultrasonic handpiece or onto any standard dental hand instrument, with the same results.

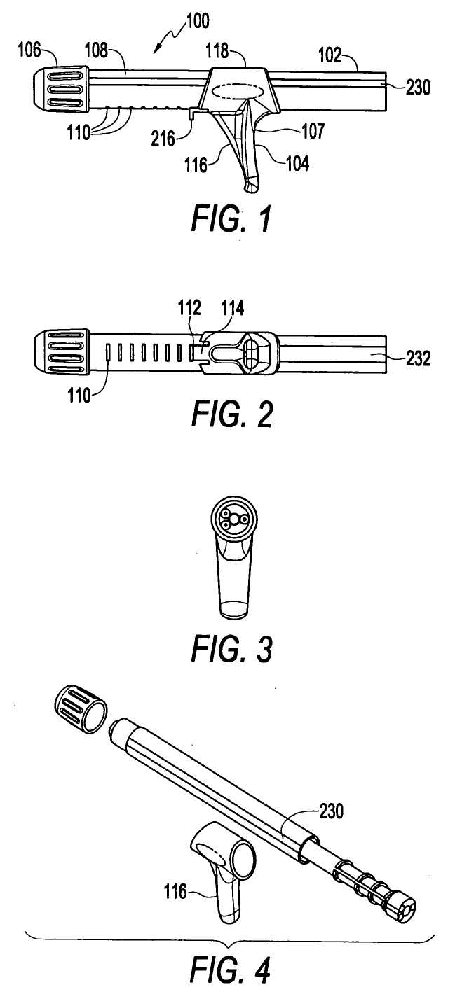

FIG. 1 shows a side view of a handpiece 100 according to one embodiment of the invention. The handpiece 100 includes a body member 102, a trigger portion 104 and a rotator portion 106. In the illustrated exemplary embodiment of the invention, the body member is a substantially tubular member having a substantially cylindrical outer surface 108, and a longitudinal internal bore disposed coaxially therethrough.

In one embodiment, the outer surface 108 includes a plurality of lateral striations disposed perpendicular to the longitudinal axis of the body member 102. As seen more clearly in FIG. 2, the striations serve to receive, one by one, and alternately, a locking projection or pawl 112 of the trigger portion 104. The pawl 112 is urged into the striations 110 by the action of a spring member 114 of the trigger portion 104.

According to various embodiments, the pawl 112 and spring member 114 may be integrally formed as a part of, and of the same material as, the balance of the trigger portion 104. For example, the entire trigger portion 104 may be formed of molded polyethylene, molded glass filled delrin, or other polymer materials as are known in the art. Alternately, the pawl 112 and/or spring member 114 may be formed of a metal or alloy such as stainless steel, titanium, polymer coated spring steel, and other appropriate materials.

The trigger portion includes a projection 116 for supporting a junction of the thumb and forefinger of a dental professional during use of the handpiece. To adjust the position of the trigger portion 104 with respect to the body member 102, the user manipulates the projection 116 with one hand and the body member 102 with the other to release the pawl 112 from the striation 110 in which the pawl is disposed. Thereafter, the trigger portion may be slid laterally along the longitudinal axis of the body 102.

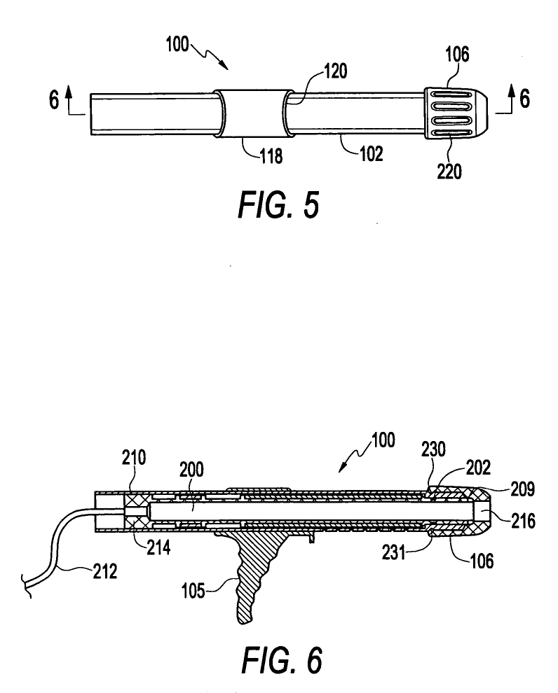

FIG. 5 shows a top view of the handpiece 100 according to one aspect of the invention. The collar, seen from above, shows the body member 102 disposed within the bore 120 thereof.

FIG. 6 illustrates a side view of the handpiece 100 that can receive an insert such as an ultrasonic insert. The handpiece 100 includes a body 102 and a rotator head 106. The rotator head 106 located at a distal end of the handpiece 100 is rotatably coupled to the rest of the handpiece 100. When the insert 200 is installed in the handpiece 100, the O-ring 202 is pressure fitted with an inner surface of the rotator head 106, such that the insert 200 rotates together with the rotator head 106.

The interconnect 210 located at a proximal end of the handpiece 100 is coupled to a cable 212 for providing electrical signals as well as fluid (e.g., water) to the handpiece 100. The interconnect 210 has a strain reliever 214 formed thereon to relieve strain between the interconnect 210 and the cable 212.

The rotator head 106 has a generally cylindrical shape, a hollow interior, and an opening at each end of the interior, which is used to receive the distal end of the body 102 at one end and a dental insert at the other end. For example, at its distal end, the rotator head 106 has formed thereon an opening 216 for receiving an ultrasonic dental tip.

The rotator head 204 has formed around its outer peripheral surface a plurality of indentations 220, as shown in FIG. 5. Each indentation 220 has an elongated elliptical (or rectangular) shape with its major axis in the direction parallel to the central axis of the handpiece 100. The indentations 220 facilitate grasping of the rotator head 106 by a dental practitioner to rotate it, for example, with respect to the body 102 (e.g., using only one hand). In other embodiments, the rotator head 106 may have a number of protrusions formed thereon instead of the indentations.

The body 102 has formed thereon a pair of grooves 230 (as shown in FIGS. 1 and 4) that are substantially equidistant from the top and traverse substantially the whole length of the body 102. The grooves 102 are used to mount a trigger portion or hand grip 104 on the handpiece 100. The body 102 has also formed thereon at its bottom near the distal end of the body 202 a plurality of substantially evenly spaced slots 110 that are used to keep the hand grip 104 from moving in the direction of the axis of the handpiece 200. The body 202 has also formed thereon at its bottom near the proximal end a groove 232 that is co-linear to the slots 230. The groove 232 engages the hand grip 104 together with the grooves 110 to keep the hand grip 104 from rotating about the central axis of the handpiece 100. The grooves may be absent in other embodiments.

The hand grip 104 has a collar or engagement portion 118, which has a generally cylindrical shape and a hollow interior. The engagement portion 118 is slipped onto the body member 102 similar to a sleeve, and engages the body member 102 such that the engagement portion envelops a portion of the body 102. The engagement portion has formed thereon a spring portion or resilient cantilever portion 114 including a pawl 112 which is used to engage one of the slots 110 on the body 102. The engagement portion or pawl 112 has attached to its bottom surface a projection or handle 116, which is used by a dental practitioner to hold the handpiece 100 during dental procedures. The handle also facilitates rotating of the rotator head 106 using one hand. The handle 104 has formed on its back surface a plurality of indentations or protrusions which are used to facilitate grasping by a dental practitioner.

Referring again to FIG. 6, the handpiece 100 further includes a retainer ring 230, which can be made of metal, such as stainless steel. The retainer ring 230 is substantially circular in shape, but does not quite form a complete circle. The retainer ring 230 is flexible (resilient) and works as a spring in that the ends that are not connected together can be brought closer together by applying pressure, but they separate when the pressure is removed.

The rotator head 106 has formed on the inner surface near its proximal end a circular groove 231 that is used to engage the retainer ring 230. The retainer ring 230 is installed in the circular groove 231, for example, by applying pressure on the retainer ring 230 to compress it, and releasing it once the retainer ring 230 has been aligned with the groove 231. Upon installation, the retainer ring 230 is locked to and is fixed with respect to the rotator head 106.

After locking the retainer ring 230 to the groove 231, the rotator head 106 is coupled with the body 102 by receiving the distal end of the body 102 into the rotator head opening at its proximal end. The body 102 has formed at its distal end an engagement portion 209, which has a radius that is smaller than the radius of the rest of the body 202. At a joint between the engagement portion 209 and the rest of the body 102 is formed a substantially circular groove 230 on an outer surface of the engagement portion 209. When the engagement portion 209 is inserted into the rotator head 204, the retainer ring 230 rotatably engages the groove 230 such that the rotator head 106 is rotatably coupled to the body 102. In other embodiments, the retaining ring 230 may be fixedly coupled to the body 102 and rotatably coupled to the rotator head 106.

In other embodiments, the hand grip 104 may be a one-piece hand grip, having a surrounding relationship with the dental handpiece. In still other embodiments, multi-piece hand grips may be used. By way of example, a two-piece handgrip may be ultrasonically welded together.

The hand grip may be made of ULTEM®, SANTOPRENE®, Xenoy® or Lexan® or other suitable resin plastic, for example.

Along its outer surface on the other side of the slightly protruding portion 98, the hand grip 104 has a contour and has a slightly concave area 107, enabling it to be easily grasped by a dental practitioner. The hand grip 104 also has formed thereon a plurality of bumps 105 (i.e., striped protrusions as shown in FIG. 6) on its external surface to further facilitate grasping of the device by a dental practitioner.

The cam surface can comprise a polymer, preferably an elastomeric polymer including natural rubber; synthetic rubber such as SBR (styrene-butadiene rubber) and Buna rubber (a synthetic rubber comprising two different monomers); silicone rubber; Viton® (a synthetic fluoropolymer from DuPont); neoprene; Santoprene from Exxon-Mobile; fluorosilicone; EPDM (ethylene/propylene/diene monomer) rubber; polyurethane rubber; nitrile (acrylonitrile butadiene) rubber and mixtures thereof.

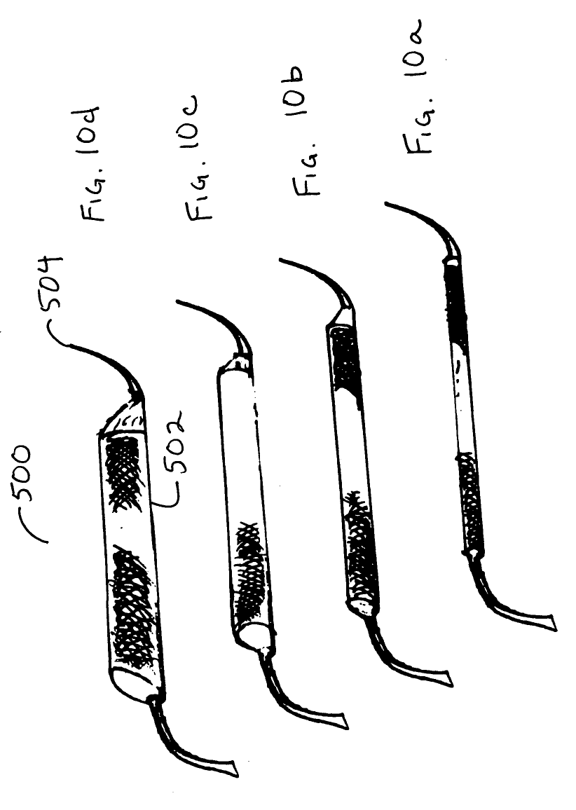

FIG. 8 shows an embodiment of the present invention. The instrument includes a handle portion 102 and a tooth contacting portion. In the illustrated embodiment, the tooth contacting portion is a scaler tip 104. According to one aspect of the invention, a vibrational mechanism is included within the handle portion 102. The vibrational mechanism is adapted to induce motion of the scaler tip 104 with respect to the handle 102, or a portion thereof. The motion of the scaler tip 104 may include a variety of oscillatory modes including flexural and elastic linear modes and torsional modes. According to one embodiment of the invention, the invention includes a switching device 106 supported by the handle portion 102. The switching device 106 allows a user to activate, and deactivate, the vibrational mechanism disposed within the handle portion 102.

According to one embodiment of the invention, an energy port 108, such as a plug receptacle, is supported by the handle portion 102. Energy such as electrical energy, maybe received through the energy port and stored within the handle portion 102 of the dental instrument. In the embodiment shown, the energy port is an electrical plug receptacle adapted to receive a conventional electrical plug.

FIG. 9 shows a system block diagram 200 of a dental instrument according to one embodiment of the invention. As shown in FIG. 103, the dental instrument includes a power storage reservoir such as an electrical battery 202. The electrical battery 202 is electrically coupled to a power control device 204. In an exemplary embodiment, the power control device 204 is an electrical switch such as a single pole-single throw switch. In various other embodiments, the power control device 204 may include an active device such as a transistor adapted to provide a variable output voltage in response to an operator signal, or a feedback signal 205. An output of the power control device 204 is electrically coupled to an input of a vibrational transducer 206. According to one embodiment of the invention, the vibrational transducer 206 includes a rotary electric motor 208, such as a permanent magnet DC motor, or a stepper motor. The rotary electric motor 208 is mechanically coupled at an output shaft thereof to a dynamically unbalanced load 212 such as an eccentric flywheel. The rotation of the dynamically unbalanced load 212 by the motor acts to produce a periodic oscillatory force on the shaft of the motor 208. The periodic oscillatory force is transmitted from the shaft of the motor 208 through bearings of the motor to a housing of the motor. From the motor housing, the oscillatory force is transmitted to the housing 102 of the instrument (as shown in FIG. 8).

According to one embodiment of the invention, the vibrational transducer 206 may produce vibrations in a range from about 10 Hz to about 10 KHz. Other frequencies, including harmonics, may be achievable, depending on the characteristics of a particular system.

According to another embodiment of the invention, the vibrational transducer 206 includes a linear motor such as a solenoid, a piezo-electric transducer or a linear stepper motor.

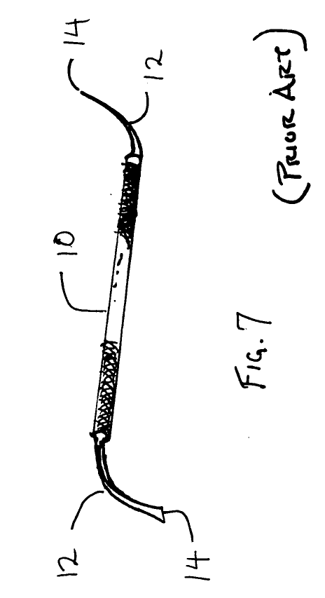

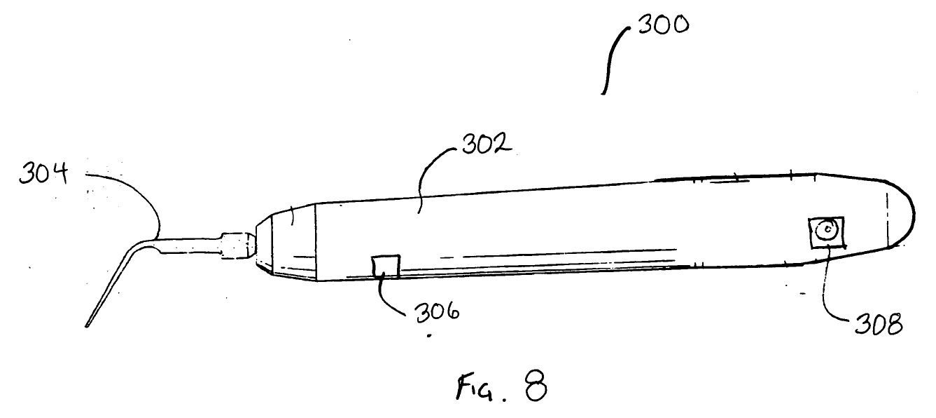

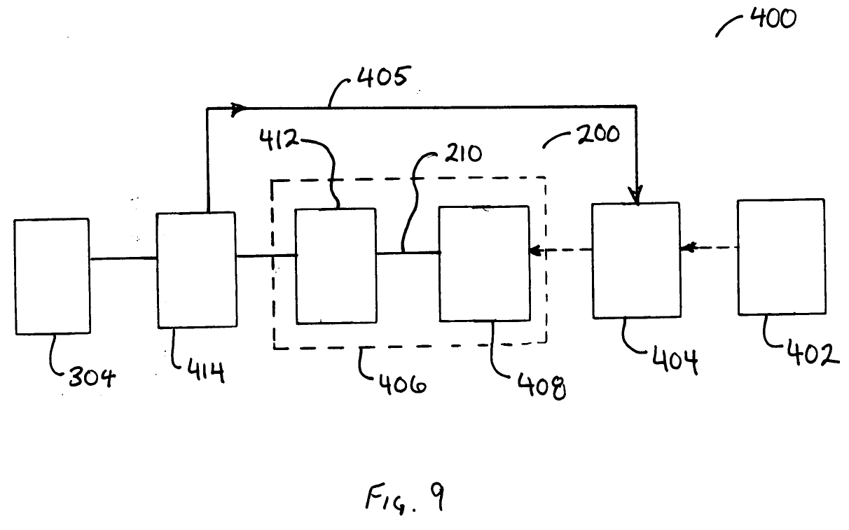

In a further aspect of the invention, the vibrational transducer 206 is mechanically coupled to a first end of a coupling member 214. The coupling member 214 may be a discrete mechanical member, or maybe integral with the housing portion 102 (as shown in FIG. 7).

The coupling member 214 is coupled at a second end to a tooth contacting portion. The tooth contacting portion may be, for example, a scaler tip 104 (as shown in FIG. 7).

The dental tip can be a scaler, as shown, or any other adapted to be fitted into a handheld instrument of the present invention, for example, a reamer, an endodontic file, a dental file or bur.

As noted, the dental tip can be present on both the distal end and the proximal end of the instrument (not shown) or it can be present on only one end.

The tapered portion can be integrally constructed as part of the handle or it can be constructed separately and then by either molding, brazing, threaded connection or any other type of attachment to attach itself to the rest of the handle. The tip can also be permanently or detachably connected to the tapered portion of either the distal or the proximal end of the handle.

The tapered portion can further be a cone-shaped portion preferably with a hollow interior, or at least part of the tapered portion can have a collar, as shown in FIG. 9.

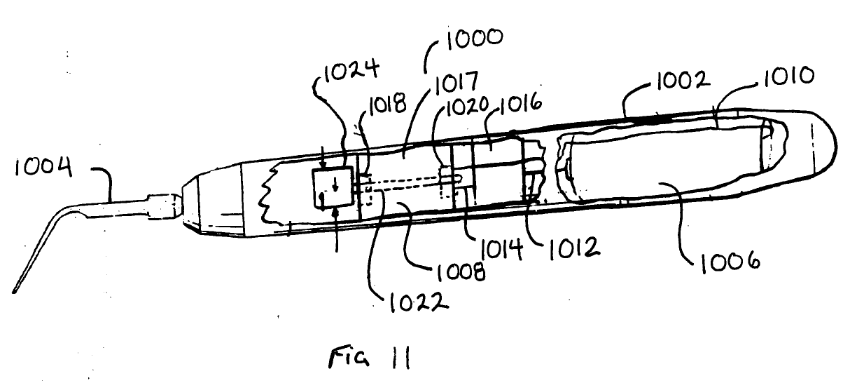

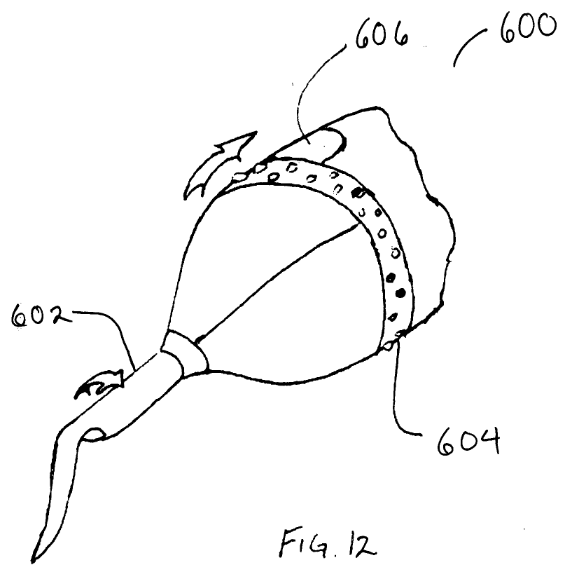

FIGS. 10a-d show a set of dental instruments, such as a dental scaler, 100 according to one embodiment of the invention. As shown, the instruments each includes a handle portion 102 and a tooth contacting portion 104. In the illustrated embodiment, the tooth contacting portion is a scaler tip.

The handle portion 102 is cylindrical and can be of a solid core, a hollow core, or a partially hollow core, preferably a hollow core, having a distal end and a proximal end. As an illustration, the diameters of the handles vary from FIG. 1a to 1d. In actuality, a series with different numbers of handles with varying diameters is contemplated. The sets of identical instruments made with varying diameters for grasping, can cut down on the repetitive action. Thus, even if the dental professional use the same type of instrument throughout the day, the hands, wrists and elbows can experience varying rather than repetitive action because the positioning of the hands, wrists and elbows are changing throughout the day.

The handle can be tapered toward either the distal end or the proximal end or both, and extending from the tapered end or ends are the dental tips adapted to be used on a patient's teeth or tooth.

The dental tip can be a scaler, as shown, or any other tip adapted to be fitted into a handheld instrument of the present invention, for example, a reamer, an endodontic file, a dental file or bur.

As noted, the dental tip can be present on both the distal end and the proximal end of the instrument (not shown) or it can be present on only one end.

The tapered portion can be integrally constructed as part of the handle or it can be constructed separately and then by either molding, brazing, threaded connection or any other type of attachment to attach itself to the rest of the handle. The tip can also be permanently or detachably connected to the tapered portion of either the distal or the proximal end of the handle.

The tapered portion can further be a cone-shaped portion preferably with a hollow interior, or at least part of the tapered portion can have a collar, as shown in FIG. 12.

The handle can be made of metal or plastic. The cone shaped portion or tapered portion or the collar can be made of the same or different material from the rest of the handle. A suitable metal can include stainless steel titanium, titanium alloys such as nickel-titanium and titanium-aluminum-vanadium alloys; aluminum, aluminum alloys; or combinations thereof. The preferred materials are stainless steel and titanium alloys. These also preferably have good flexibility.

A suitable non-metal can include a polymeric material, such as high temperature plastics including such as ULTEM®, which is an amorphous thermoplastic polyetherimide or Xenoy® resin, which is a composite of polycarbonate and polybutyleneterephthalate or Lexan® plastic, which is a copolymer of polycarbonate and isophthalate terephthalate resorcinol resin, all available from GE Plastics, or any other suitable resin plastic or composite.

Likewise, the tip can also be either made of metal or plastic and the same or similar materials suitable for the handle portion is also suitable for the tip. As noted above, the tip can also be in the form of a scalar, an endodontic file, a reamer, a dental file or a bur.

Preferably, bumps and/or striations and/or other means are formed on the gripping portion of the handle for better non-slip grip.

Preferably, the cone-portion or tapered portion, or collar, if removable, is preferably made of a plastic material even if the rest of the handle is made of a metal or metal alloy.

As noted, the set of instruments shown in FIGS. 10a-d are identical, except for the diameters of the handles.

While this invention is described in detail with reference to certain preferred embodiments, it should be appreciated that the present invention is not limited to those precise embodiments. Rather, in view of the present disclosure which describes the current best mode for practicing the invention, many modifications and variations would present themselves to those of skill in the art without departing from the scope and spirit of this invention.

1. A dental tool comprising:
an elongated handpiece having a body with an interior, a distal end, a proximal end, and a longitudinal portion in between;
a cylindrical grip portion attached to the body of the handpiece anywhere between the distal end and the proximal end;
said grip portion comprising a locking mechanism.

2. The dental tool of claim 1 wherein at least one insert is present on the handpiece at one end.

3. The dental tool of claim 1 wherein said grip portion is in the form of a pistol grip.

4. The dental tool of claim 1 wherein said grip portion is slidable along the elongated handpiece.

5. The dental tool of claim 4 wherein said grip portion can be locked into place along the longitudinal portion of the handpiece to fit the hand size of different users.

6. The dental tool of claim 3 wherein the grip portion comprises a trigger for adjusting the locking mechanism.

7. The dental tool of claim 1 wherein said grip portion functions as a contra balance and lever to the handpiece to reduce a pressure on an operator's fingers and wrists.

8. The dental tool of claim 1 wherein said locking mechanism comprises a lever connected to a cam surface.

9. The dental tool of claim 8 wherein said cam surface engages the outer surface of the handpiece when the lever is pressed.

10. The dental tool of claim 1 wherein said locking mechanism comprises a device adapted to apply positive pressure on an external surface of the handpiece.

11. The dental tool of claim 1 wherein said locking mechanism comprises an interlocking with an element of the handpiece.

12. The dental tool of claim 1 wherein said at least one dental insert is selected from the group consisting of a dental drill bit insert; a rotary tool insert; an endodontic file; a reamer; a prophy angle and combinations thereof.

13. The dental tool of claim 12 wherein said rotary tool insert is selected from the group consisting of such as a multi-use diamond dental bur; a dental carbide bur; a dental sintered diamond bur; a dental diamond disc; a dental laboratory tungsten carbide cutter; and dental steel bur and combinations thereof.

14. A dental tool comprising:
a handpiece comprising a body having a substantially hollow interior for housing functional parts of the dental tool, a proximal end and a distal end and a longitudinal portion in between;
a grip portion attached to the body of the handpiece anywhere between the distal end and the proximal end;
Wherein said grip portion is slidably along the longitudinal portion of the handpiece and comprises a grip stop.

15. The dental tool of claim 14 wherein at least one insert is present on the handpiece at one end.

16. The dental tool of claim 14 wherein said grip portion is in the form of a pistol grip.

17. The dental tool of claim 14 wherein said grip portion can be locked into place along the longitudinal portion of the handpiece to fit the hand size of different users.

18. The dental tool of claim 14 further comprising a locking mechanism.

19. The dental tool of claim 14 wherein said grip portion functions as a contra balance and lever to the handpiece to reduce the pressure on the operator's fingers and wrists.

20. The dental tool of claim 18 wherein said locking mechanism comprises a lever connected to a cam surface.

21. The dental tool of claim 1 further comprising at least one vibrator module positioned and supported inside the body.

22. The dental tool of claim 21 wherein said vibrator module comprises a small motor for rotating an eccentric weight to cause a vibration in the instrument.

23. The dental tool of claim 21 further comprising an anti-rotation means for preventing said vibrator module from rotating relative to said housing when said vibratory tool is in used.

24. The dental tool of claim 21 wherein said body is tapered towards at least one end.

25. The dental tool of claim 24 wherein said tapered end comprises a structure selected from the group consisting of a cone-shaped portion, a collar and combinations thereof.

26. The dental tool of claim 25 wherein said structure is integrally formed as part of the body.

27. The dental tool of claim 1 wherein the dental tool comprises a set having bodies of varying diameters.

28. The dental tool of claim 27 further comprising at least one vibrator module positioned and supported inside the body.

29. The dental tool of claim 14 further comprising at least one vibrator module positioned and supported inside the body.

30. The dental tool of claim 14 wherein the dental tool comprises a set having bodies of varying diameters.

31. The dental tool of claim 30 further comprising at least one vibrator module positioned and supported inside the body.

32. A set of identical dental instruments comprising handles with varying diameters, each of said instrument comprises a handpiece comprising a body having a substantially hollow interior for housing functional parts of the dental tool, a proximal end and a distal end and a longitudinal portion in between;
a grip portion attached to the body of the handpiece anywhere between the distal end and the proximal end;
said grip portion comprising a locking mechanism.

33. The dental instrument of claim 32 further comprising at least one vibrator module positioned and supported inside the body.

34. The dental instrument of claim 32 wherein said grip portion is slidably along the longitudinal portion of the handpiece.

35. The dental instrument of claim 32 wherein said locking mechanism comprises a grip stop.

36. The dental tool of claim 1 wherein said at least one dental insert includes a scaler.

37. The dental tool of claim 1 wherein said body comprises a solid, hollow or partially solid interior.
